(19) United States
(12) Patent Application Publication
(10) Pub. No.: US 2026/0060228 A1
(43) Pub. Date: Mar. 5, 2026

(54) Adaptive Rod Holder

(71) Applicant: David Baynard, Manning, SC (US)

(72) Inventor: David Baynard, Manning, SC (US)

(21) Appl. No.: 18/824,134

(22) Filed: Sep. 4, 2024

(51) Int. Cl. A01K 97/10

(52) U.S. Cl. CPC A01K 97/10

(57) ABSTRACT

An adaptive rod holder may be used in conjunction with a flush mount style rod holder, which allows a rod to be disposed in an angular range of 0° (horizontal) to about 50° above horizontal. The adaptive rod holder includes a tubular base member with a top end and a bottom end, wherein the top end is preferably disposed in a horizontal plane, and a rod holder member that is removably attached to the top end of the tubular base member so that the rod holder member may be rotationally adjustable within a 360° range. In some embodiments, the rod holder member is also angularly adjustable upwardly and downwardly.

### BACKGROUND OF THE INVENTION

Flush mount rod holders are commonly found on fishing boats, including kayaks and center-console types of boats. These flush mount rod holders are typically tubes that are installed in the gunwale or sides of the boat, and the tubes may be disposed at an angle, so that the bottom end of a fishing rod is disposed within the tube. The flush mount rod holders may be used to hold rods while trolling or bottom fishing, and many of these flush mount rod holders include one or more support bars or pins extending across a bottom portion thereof for supporting a fishing rod. Some fishing rods also include a transverse notch across the bottom portion thereof, so that the transverse notch engages with the support pin to prevent the fishing rod from twisting within the tube.

Flush mount rod holders have some disadvantages, in that they do not allow any type of adjustment for the position of the fishing rod held therein. Further, in some situations, it is preferred to position a fishing rod at a generally horizontal angle, or at an angle that is much closer to horizontal than a standard flush mount rod holder allows. Traditionally, flush mount rod holders are disposed in one of three positions: 1) vertically, 2) at a 75° angle from horizontal (or 15° from vertical), or 3) at a 60° angle from horizontal (or 30° from vertical).

Anglers, who fish for freshwater game fish like largemouth bass, striped bass and catfish, often use mounted rod holders that position the fishing rods between about 0° (horizontal) to about 50° above horizontal. Some mounted rod holders allow for the fishing rod to be deployed in multiple angular positions, such as the rod holder set forth in U.S. Pat. No. 6,487,813, which is incorporated herein by reference, in its entirety.

Other types of fishing rod holders have been developed, and the following documents are incorporated herein by reference, in their entireties:

### U.S. Pat. No. 4,827,654—Fishing Rod Holder for Casting and Spinning Reels

A fishing rod holder for casting and spinning reels includes a holster portion for receiving a rod with a rigid clamp rotatably mounted on one end of the holster portion for retaining a reel within the holster portion. The rigid clamp includes an integral appendage which locks into said holster portion a spinning reel depending from a rod outside of the holster. The fishing rod holder further includes a support post rotatably attached to the holster portion and a mount which is attachable to a base structure, the mount including a barrel portion for receiving the support post. Shoulders on the post and on the holster portion limit the forward pivot of the holster. The support post includes a protrusion on one end with the barrel including a groove in its inner surface for receiving the protrusion, whereby the post can be partially inserted into and rotated within the barrel with the protrusion preventing removal of the post from the barrel unless the protrusion is aligned with the groove.

### U.S. Pat. No. 11,771,072—Convertible Tube Adapter

A convertible tube adapter including a top connection point, a shaft, a bottom connection point and a knob. The top connection point includes a plurality of connection contacts integrated on a first side of the top connection point, a fastener receiving surface integrated on a second side of the top connection point and an aperture incorporated between the plurality of connection contacts and the fastener receiving surface. The shaft is configured for insertion into a tube which is fixedly integrated into an object. The shaft includes a pair of bumpers located on each side, which each extends outward from a side surface of the shaft. The bottom connection point is attached to a bottom end of the shaft and includes a carve-out structure integrated into its rear surface which is configured to receive a mating pin positioned at the bottom of the tube to prevent the adapter from rotating in the tube. The adapter is configured to effectively convert the tube into a mount when the shaft is inserted into the tube by allowing an article to attach to the top connection point of the adapter.

### U.S. Patent Application Pub. No. 20230382498—Quick Release Pin Marine Mount System for Rod Holders and Accessories

Disclosed are apparatus and corresponding and/or associated methodology for a surface mounted base/pin system that allows a user (boater/fisherman) to quickly relocate or remove the desired accessory from one location to another by actuating the pin system which releases the unit from the base. The subject base/pin system uses a plurality of grooves in a base component and a plurality of balls in a pin component to strengthen the unit and for providing rotational locking positions as desired. The reinforced-strength base/pin system can support rod holders or other marine-associated accessories (such as bumper cleats, tie-down cleats, downrigging systems or others).

### SUMMARY OF THE INVENTION

In one embodiment, the present invention includes an adaptive rod holder having a tubular base member with a top end and a bottom end, wherein the top end is preferably disposed in a horizontal plane, and preferably includes a top plate defining a threaded hole, which serves as a mount for receiving a rod holder member that holds a fishing rod at an angle in the range of 0° (horizontal) to about 50° above horizontal.

In one embodiment, the rod holder member includes a base plate defining a hole therein, so that the rod holder member may be attached to the top end of the tubular base member with a bolt that extends downwardly into a threaded hole that is disposed in the top end of the tubular base member. This arrangement allows the rod holder member attached to the top end of the tubular base member to be rotationally adjustable, so that the rod holder member may be rotated about a 360° axis and secured into place thereon.

Optionally, the bottom end of the tubular base member may include a transverse notch that engages with a transverse support pin that extends across the bottom of a flush mount rod holder, so that when the tubular base member is placed into the flush mount rod holder, the tubular base member is prevented from rotating therein. This arrangement provides for an adaptive rod holder that is rotationally adjustable with respect to the tubular base member, which is removably disposed within a flush mount rod holder so that the adaptive rod holder remains facing in a fixed position relative to the flush mount rod holder (and, thereby, a boat).

In some embodiments, a different type of mount may be used to attach the rod holder member to the top of the tubular base member, so that the rod holder member is angularly adjustable (upwardly or downwardly). There are many mechanisms that may be used to provide this angular adjustment between the rod holder member and the tubular base member, including ball and socket joints, a pivoting arrangement that allows the rod holder member to pivot upwardly and downwardly about a pin or bolt axis, and other such mechanisms that are familiar to those skilled in the art.

### BRIEF DESCRIPTION OF THE DRAWINGS

These and other features, aspects, and advantages of the present invention will become better understood with regard to the following description, appended claims, and accompanying drawings where:

FIG. 1 is an elevated perspective view of one embodiment of an adaptive rod holder with a fishing rod attached thereto, wherein the adaptive rod holder includes a tubular base member with a rod holder member attached to a horizontally oriented top plate member positioned on an upper portion of the tubular base member, wherein the adaptive rod holder is positioned within a flush mount rod holder so that the tubular base member extends angularly down into the flush mount rod holder;

FIG. 2 illustrates a perspective view of one embodiment of a flush mount rod holder commonly found on many fishing boats, wherein the flush mount rod holder includes a tubular body member extending downwardly at an angle from the top surface of a gunwale of a boat, and wherein the bottom portion of the tubular body member includes a transverse pin to support a fishing rod or a tubular base member of an adaptive rod holder as set forth herein;

FIG. 3 illustrates a perspective view of one embodiment of a tubular base member of an adaptive rod holder, wherein the tubular base member includes a horizontally oriented top plate defining a threaded hole for receiving a bolt or the like for attachment of a rod holder member;

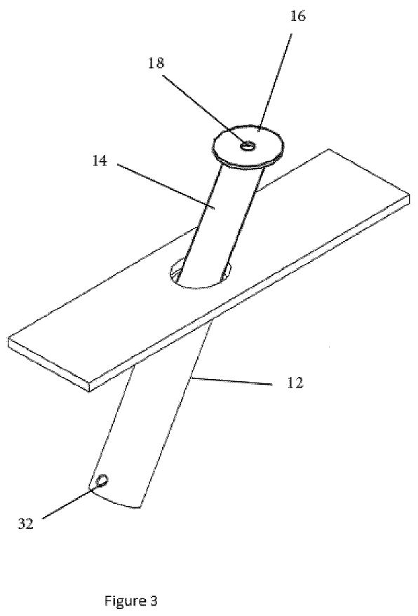

FIG. 4 is an elevated perspective view of one embodiment of a rod holder member having a front fork, a rear rod retention element, a and rod holder base plate defining a hole in a central portion thereof for receiving a bolt or the like for attachment to a tubular base member;

FIG. 5 is an elevated perspective view of one embodiment of an adaptive rod holder, wherein the rod holder element is supporting a fishing rod by the front fork and the rear retention element, and wherein the rod holder member has been rotated leftward in a horizontal plane with respect to the tubular base member;

FIG. 6 is an elevated perspective view of one embodiment of an adaptive rod holder, wherein the rod holder element is facing rearwardly with respect to the tubular base member;

FIG. 7 is an elevated perspective view of another embodiment of an adaptive rod holder, wherein the top of the tubular base member includes a top member having a base tab defining a hole therein, and an angularly adjustable mount member includes a top plate member defining a hole in a central portion thereof for receiving a bolt to attach a rod holder member, a pair of downwardly projecting, rounded mount tabs extending from a bottom of the top plate member so that the mount tabs are spaced apart in parallel planes, so that the base tab is positioned between the mount tabs so that the respective holes in the base tab and the mount tabs are in alignment, and further showing a pin extending through these holes to provide an angularly adjustable mount in an upward and downward direction; and

FIG. 8 is a side view of another embodiment of a tubular base member of an adaptive rod holder, wherein the tubular base member includes a bend, so that the bottom portion of the tubular base member may extend into an angled flush mount rod holder, and the tubular base member is bent so that the top plate member is disposed in a horizontal plane for receiving a rod holder member.

### DETAILED DESCRIPTION OF THE INVENTION

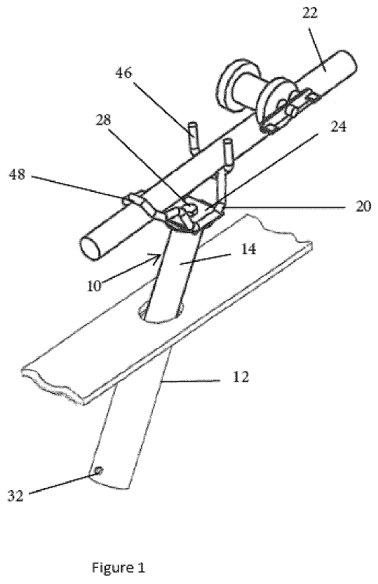

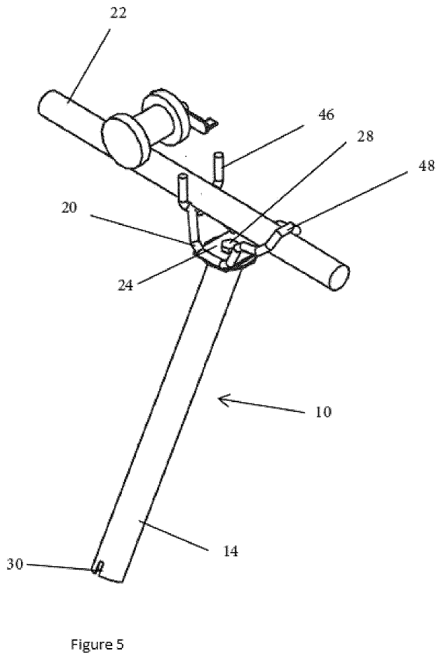

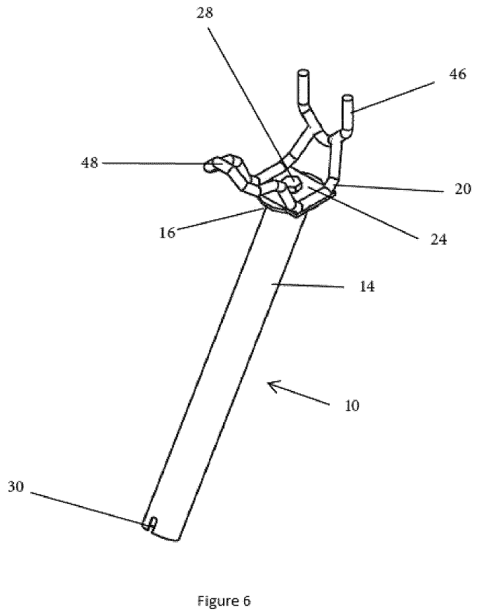

The present invention, in a first embodiment, is an adaptive rod holder 10 that may be used in conjunction with a flush mount style rod holder 12, which allows a rod to be disposed in an angular range of 0° (horizontal) to about 50°, as shown in FIG. 1. The adaptive rod holder 10 includes a tubular base member 14 with a top end and a bottom end, wherein the top end is preferably disposed in a horizontal plane, and preferably includes a horizontally oriented top plate 16 defining a threaded hole 18, which serves as a mount for receiving a rod holder member 20 that holds a fishing rod 22 at a different angle than the angle of a flush mount rod holder 12. In this embodiment, the rod holder member 20 includes a base plate 24 with a hole 26 defined therein, and is attached to the top end of the tubular base member 14 by placing a bolt 28 through the hole 26 in the base plate 24 of the rod holder member 20 and into the threaded hole 18 in the top plate 16 of the tubular base member 14, and tightening the bolt 28 until the rod holder member 20 is secured thereto in a desired right/left direction, as shown in FIGS. 1, 5 and 6. To rotationally adjust the rod holder member 20 at the top of the tubular base member 14, the bolt 28 may be loosened so that the rod holder member 20 may rotate to the desired position, and the bolt 28 may then be tightened to secure the rod holder member 20 to the tubular base member in any desired rotational position (right or left). This arrangement allows the rod holder member 20 attached to the top end of the tubular base member 14 to be rotationally adjustable, so that the rod holder member may be rotated about a 360° axis and secured into place thereon, while maintaining the same vertical elevation throughout that 360° arc.

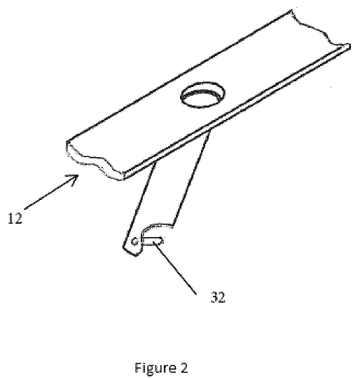

Optionally, the bottom end of the tubular base member 14 may include a transverse notch 30 that engages with a transverse support pin 32 that extends across the bottom of a flush mount rod holder 12, as shown in FIG. 2, so that when the tubular base member 14 is placed into the flush mount rod holder 12, the tubular base member 14 is prevented from rotating therein. This arrangement provides for an adaptive rod holder 10 that is rotationally adjustable with respect to the tubular base member 14, which is removably disposed and rotationally fixed within a flush mount rod holder 12 so that the adaptive rod holder 10 remains facing in one direction in a fixed position within the flush mount rod holder 12.

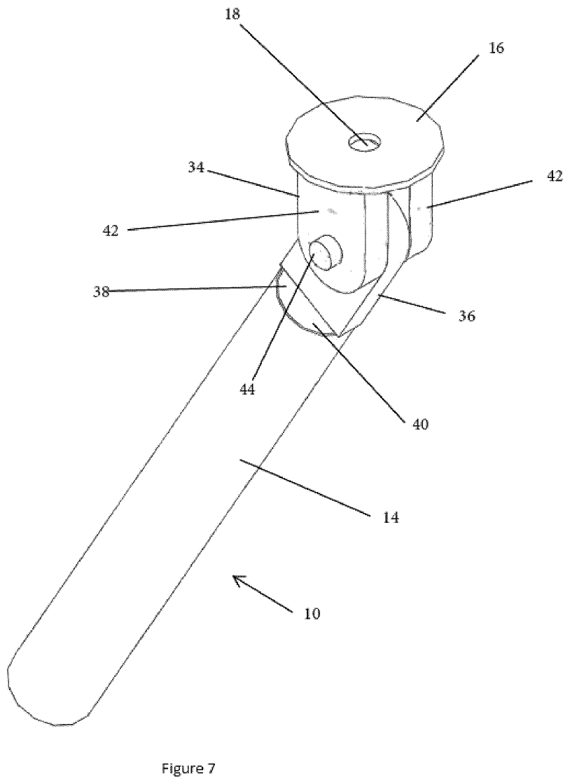

In some embodiments, a vertical angular mount 34 may be used to attach the rod holder member 20 to the top of the tubular base member 14, so that the rod holder member 20 is angularly adjustable (upwardly or downwardly), one example of which is shown in FIG. 7. In this embodiment, an end cap 38 at the top portion of the tubular base member 14 includes a generally flat main body member 40 and a base tab 36 that extends outwardly from the main body member 40, so that the base tab 36 is oriented in a plane that is perpendicular to the main body member 40 thereof. The base tab 36 is preferably rounded at the distal end, as shown, and preferably defines a hole in a central portion thereof. The vertical angular mount 34 includes a top plate 16 defining a hole therein 18 (which is preferably threaded) for receiving a threaded bolt 28, so that the rod holder member 20 may be attached thereto, as described hereinabove. The vertical angular mount 34 further includes a pair of rounded mount tabs 42 extending downwardly from an underside of the top plate 16, wherein the mount tabs 42 are spaced apart in parallel planes, and each mount tab 42 defines a hole in a central portion thereof. The base tab 36 of the end cap 38 may be positioned between the mount tabs 42 of the vertical angular mount 34, so that the holes of the mount tabs 42 align with the hole in the base tab 36, so that a pin 44, screw, bolt or the like may pass therethrough to adjustably secure the vertical angular mount 34 to the end cap 38 of at the top end of the tubular base member 14, so that the vertical angular mount 34 is angularly adjustable upwardly and downwardly, as shown in FIG. 7.

Other mechanisms may be used, as well, to provide such vertical angular adjustment. For example, in this embodiment, an L-shaped bracket (not shown) may include a hole in the horizontal tab of the bracket, and a second hole in the vertical tab of the bracket. The horizontal tab is affixed to the top of the tubular base member with a bolt, in the manner described hereinabove. The base plate 24 of the rod holder member 20, in this example, includes a rounded mount tab 42 that is disposed in a downwardly vertical orientation from the underside of the base plate 24, wherein the (downwardly oriented) mount tab 42 of the base plate 24 may be secured to the (upwardly oriented) vertical tab of the L-shaped bracket by using a bolt and wingnut, for instance, or any other suitable tightening means. To angularly adjust the rod holder member 20 with respect to the tubular base member 14, a user simply loosens the wing nut and angularly adjusts the rod holder member 20 upwardly or downwardly to the desired position, and then tightens the wing nut to secure the rod holder member 20 to the L-shaped bracket in the desired angular configuration. It should be understood that other types of mounts may be used to provide both the rotational adjustability (rightwardly and leftwardly) and angular adjustability (upwardly and downwardly), as will be recognized by those skilled in the art.

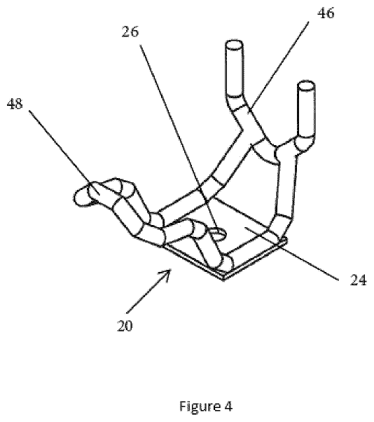

The rod holder member 20 that attaches to the tubular base member 14 can take many different configurations. In some embodiments, the rod holder member 20, as shown in FIG. 4 includes a front end and a rear end, wherein the front end is configured into a fork support comprising a generally Y shape for supporting a rod from underneath, and the rear end includes a rod retention element 48 that extends over the top of a bottom portion of a fishing rod, as shown in FIG. 1, and 5-6. This configuration is well-known in the art. The rod holder member may further include a base plate 24, as described hereinabove, and as shown in FIGS. 1 and 4-6 wherein the base plate 24 is used to removably affix the rod holder member 20 to the tubular base member 14 via a bolt 28, screw or the like, as described above.

It should be understood that other configurations for the rod holder member may be used, including a variation of the dual position rod holder set forth in U.S. Pat. No. 6,487,813. In this embodiment, a rod holder member may include a front fork support and a plurality of rod retention elements spaced from the front support fork which position and retain the fishing rod in different elevations and fishing positions.

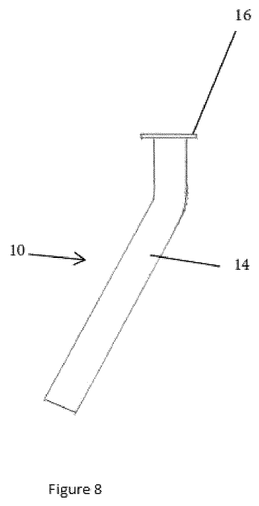

In another, simplified embodiment, the tubular base member 14 may have an angular bend, as shown in FIG. 8, so that the top plate member 16 is disposed in a horizontal plane. In this embodiment, the rod holder member 20 is attached to the top plate member 16 as described above, and may be rotated rightwardly or leftwardly in a 360° arc while maintaining the same vertical disposition throughout that arc.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. An adaptive fishing rod holder comprising:
a tubular base member having a top end and a bottom end, wherein said top end of said tubular base member includes a top plate that is oriented in a generally horizontal plane when said tubular member is disposed at an angle of between 60° and 90° from a horizontal plane;
a rod holder member having a front support fork, a rear rod retention element and a base plate disposed in a horizontal plane to maintain a fishing rod at a predetermined elevation, said rod holder member being removably attached to said top end of said tubular base member;
wherein said rod holder member is rotationally adjustable rightwardly and leftwardly with respect to said tubular base member so that said rod holder member may be temporarily affixed to said tubular base member in any direction within a 360° range while maintaining said predetermined elevation; and
wherein said tubular base member extends downwardly from said base plate of said rod holder member at an angular range of between 90° and 60° relative to said horizontally disposed rod holder base plate.

2. The adaptive rod holder set forth in claim 1, wherein said bottom end of said tubular base member includes a transversely oriented notch for receiving and engaging with a transverse support pin.

3. The adaptive rod holder set forth in claim 1, wherein said rod holder member is angularly adjustable in a vertical direction so that said rod holder member may be adjusted upwardly or downwardly with respect to said tubular base member.

4. The adaptive rod holder set forth in claim 3, wherein said rod holder member is angularly adjustable to select said predetermined elevation in a range between a horizontal angle of 0° to an upward angle of 50° above a horizontal plane.

5. The adaptive rod holder set forth in claim 1, wherein said rod holder member includes a plurality of rod retention elements that are spaced apart from said front support fork in order to position and retain a fishing rod in one of multiple elevations and fishing positions.

6. An adaptive fishing rod holder comprising:
a tubular base member having a top portion with a top end and a bottom portion with a bottom end, wherein said top portion of said tubular base member is disposed in a generally vertical direction, and said bottom portion of said tubular base member is disposed at an angle in with respect to said top portion of said tubular base member;
a rod holder member having a front support fork, a rear rod retention element and a base plate disposed in a horizontal plane to maintain a fishing rod at a predetermined elevation, said rod holder member being removably attached to said top end of said tubular base member;
wherein said rod holder member is rotationally adjustable rightwardly and leftwardly with respect to said tubular base member so that said rod holder member may be temporarily affixed to said tubular base member in any direction within a 360° range while maintaining said predetermined elevation; and
wherein said tubular base member extends downwardly from said base plate of said rod holder member at an angular range of between 90° and 60° relative to said horizontally disposed rod holder base plate.

7. The adaptive rod holder set forth in claim 6, wherein said bottom end of said tubular base member includes a transversely oriented notch for receiving and engaging with a transverse support pin.

8. The adaptive rod holder set forth in claim 6, wherein said rod holder member includes a plurality of rod retention elements that are spaced apart from said front support fork in order to position and retain a fishing rod in one of multiple elevations and fishing positions.
